(19) United States
(12) Patent Application Publication
(10) Pub. No.: US 2023/0219416 A1
(43) Pub. Date: Jul. 13, 2023

(54) Blinker Steering Wheel Buttons

(71) Applicant: Shaun Rogers, Sylmar, CA (US)

(72) Inventor: Shaun Rogers, Sylmar, CA (US)

(21) Appl. No.: 17/572,877

(22) Filed: Jan. 11, 2022

(51) Int. Cl. B60K 35/00; B60Q 1/34; B60R 16/027; B62D 1/04

(52) U.S. Cl. CPC B60K 35/00; B60Q 1/346; B60R 16/027; B62D 1/04; B60K 2370/12; B60K 2370/157; B60K 2370/158; B60K 2370/782

(57) ABSTRACT

The Blinker Button is the only product of its kind that integrates the blinker turn signal buttons onto the steering wheel to provide drivers with a quicker method of signaling their turns. This unprecedented product is uniquely designed with buttons that are specifically developed for the right and left thumb and that are strategically located on the top of the steering wheel where individuals most commonly hold their steering wheel, in the 10 and 2 and/or 9 and 3, clock-reference training for operating a vehicle. The disclosure also includes a programmable logic configured to activate the left turn signal automatically based on a predetermined left rotation of the steering wheel and configured to activate the right turn signal automatically based on a predetermined right rotation of the steering wheel in relation to a zero rotation of the steering wheel for a straight travel of the vehicle.

### BACKGROUND

A common complaint from many drivers refers to other drivers who change lanes, or who turn left or right, and do not signal as a precaution notice. Drivers who do not use their turn signals correctly, or at all, are a great danger to others on the road and increase the likelihood of vehicle collisions. Such drivers often credit their lack of signaling to inconvenience, laziness, and the time it takes to do so. There have been no products available as original equipment or as an aftermarket to address this problem.

An apparatus to simplify the process of using the blinker turn signals in a vehicle. There have been no products available as original equipment or as an aftermarket to address this problem either.

There exists a need for system such as the Blinker Steering Wheel that is not being met by any known or disclosed device or system of present.

### SUMMARY OF THE INVENTION

The main purpose of the Blinker Steering Wheel Buttons is to provide an accessory with an immediate control option for blinkers, on steering wheels, to foster consistent use.

A steering wheel for a vehicle as disclosed includes a left button for a left turn signal on the steering wheel and a right button for right turn signal on the steering wheel. The disclosure also includes a programmable logic configured to activate the left turn signal automatically based on a predetermined left rotation of the steering wheel and configured to activate the right turn signal based on a predetermined right rotation of the steering wheel in relation to a zero rotation of the steering wheel for a straight travel of the vehicle.

### BRIEF DESCRIPTION OF THE DRAWINGS

FIG. 1 is a front elevational view of the Blinker Steering Wheel Buttons in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

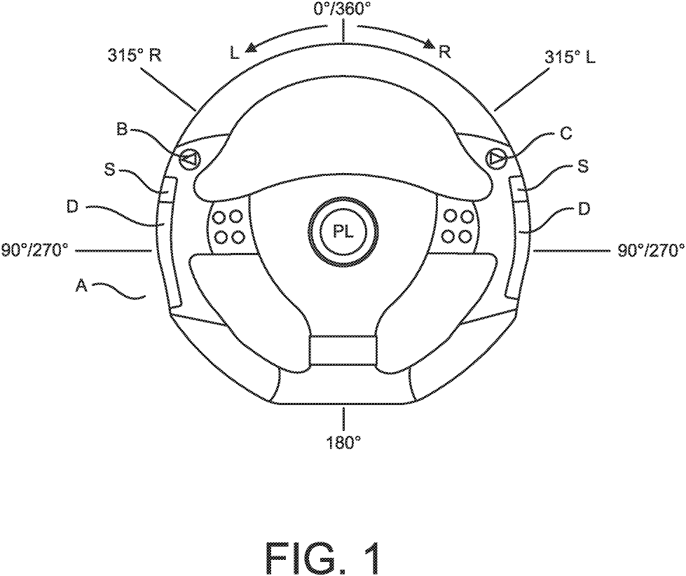

FIG. 1 is a front elevational view of the Blinker Steering Wheel Buttons showing: Steering wheel referenced as A, Left thumb button for left turn signal referenced as B, Right thumb button for right turn signal referenced as C, in accordance with an embodiment of the present disclosure. The view also includes a vibrator D for a left side of the steering wheel and another vibrator D for a right side of the steering wheel. Speakers S are also included for audible signals. The thumb buttons B and C also light up on an activation in embodiments of the disclosure. A rotation of the steering wheel notated as L for left and R for right are in relation to a zero rotation for a straight steering the vehicle. Ninety degree increments are noted for a left and for a right rotation. The programmable logic PL includes circuits and sensors to indicate the degree of rotation and to store in memory and in state machine design and otherwise electronic circuits the predetermined rotation and to compare the predetermined rotation with an actual rotation in use of the vehicle. Therefore, what has been an automatic shutoff of blinker signals is now improved to be an automatic turnon of blinker signals and notice through vibration for hearing impaired people. Flashers are also activated by a simultaneous depression of both blinker buttons and associated signals by vibration and by light and audio as disclosed herein.

The present disclosed Blinker Steering Wheel Buttons , also known as “The Blinker Button”, offers a modem accessory that provides users with an accessible and simple means of activating their turn signals in an attempt to increase the likelihood of drivers using them on the road. Expanding on the initial design of an average steering wheel, The Blinker Button introduces two novel buttons possessing a light feature, located on each corresponding side of the steering wheel. The user simply presses the button located on either the left or right side to activate the turn signal for that direction while the light serves to affirm the selection is made. After the turn is completed, it will automatically turn off. As a result, driers may be willing, motivated and inclined to user their turn signals, considering it would become effortless to perform the act. The Blinker button makes using turn signals more convenient, which may reduce the number of individuals who do not user their turn signals, and therefore allows for an overall safer driving experience for both the driver and others on the road as well as passengers within a moving car and pedestrian in the street.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed:

1. A steering wheelfor a vehicle comprising:
a left button for a left turn signal on the steering wheel;
a right button for right turn signal on the steering wheel; and
a programmable logic configured to activate the left turn signal based on a predetermined left rotation of the steering wheel and configured to activate the right turn signal based on a predetermined right rotation of the steering wheel in relation to a zero rotation of the steering wheel for a straight travel of the vehicle.

2. The steering wheel of claim 1, wherein the left turn signal is a vibrator in an electrical communication with the left thumb button.

3. The steering wheel of claim 1, wherein the right turn signal is a vibrator in an electrical communication with the right button.

4. The steering wheel of claim 1, wherein the left turn signal is an audible signal in an electrical communication with the left button.

5. The steering wheel of claim 1, wherein the right turn signal is an audible signal in an electrical communication with the right button.

6. The steering wheel of claim 1, wherein the left turn signal is a visual signal in an electrical communication with the left button.

7. The steering wheel of claim 1, wherein the right thumb button is a visual signal in an electrical communication with the right button.

8. The steering wheel of claim 1, wherein the predetermined left rotation of the steering wheel is a three hundred and fifteen degree rotation.

9. The steering wheel of claim 1, wherein the predetermined right rotation of the steering wheel is a three hundred and fifteen degree rotation.

10. The steering wheel of claim 1, wherein the predetermined right and left rotation of the steering wheel is any rotation larger than a two hundred and seventy degree rotation.

11. The steering wheel of claim 1, further comprising a circuit configured to measure a right and a left rotation of the steering wheel.

12. The steering wheel of claim 1, further comprising a circuit configured to compare a right rotation of the steering wheel to the predetermined right rotation.

13. The steering wheel of claim 1, further comprising a circuit configured to compare a left rotation of the steering wheel to the predetermined left rotation.

14. The steering wheel of claim 1, wherein a simultaneous depression of the left button and the right buttons activates a flasher function of both the left and the right turn signals simultaneously.

15. The steering wheel of claim 1, wherein the right button and the left button are thumb buttons configured in reach of a driver’s respective thumbs.

16. The steering wheel of claim 1, wherein the left button and the right button are finger buttons configured in reach of a driver’s respective fingers.
